(19) United States
(12) Patent Application Publication
(10) Pub. No.: US 2004/0114362 A1
(43) Pub. Date: Jun. 17, 2004

(54) Decorative device having light device for vehicle

(76) Inventor: Tzu Hsiu Chang, Taichung (TW)

Correspondence Address: Tzu Hsiu Chang, P.O. Box 63-99, Taichung, 406, TW

(21) Appl. No.: 10/320,134

(22) Filed: Dec. 13, 2002

(51) Int. Cl. F21S 8/10

(52) U.S. Cl. 362/219; 362/240; 362/236; 362/222; 362/217; 362/545; 362/494

(57) ABSTRACT

A decorative device for attaching onto objects includes an elongate housing having a peripheral wall extended from an outer peripheral portion of a bottom panel, and a covering having an outer peripheral portion engaged and secured to the peripheral wall of the housing. A circuit board is secured in the housing, and has one or more light devices to generate warning light. The housing may be attached to the side portions of the vehicles for lighting the side portions of the vehicles, and for preventing the side portions of the vehicles from being hit by the other vehicles.

### BACKGROUND OF THE INVENTION

1. Field of the Invention

The present invention relates to a decorative device, and more particularly to a decorative device having one or more light devices, for attaching to vehicles, and for generating warning lights for the vehicles.

2. Description of the Prior Art

Typical decorative devices or straps or bars are made of rubber or plastic or synthetic materials, and are provided for attaching onto the sides or the front or the rear portions of the vehicles, for preventing the vehicles from being scratched by the other objects. However, the typical decorative devices may not generate warning lights for the vehicles. Particularly, the side portions of the vehicles have no warning device or warning light generating devices, such that the side portions of the vehicles may not be clearly seen in the dark environment.

The present invention has arisen to mitigate and/or obviate the afore-described disadvantages of the conventional decorative devices.

### SUMMARY OF THE INVENTION

The primary objective of the present invention is to provide a decorative device including one or more light devices provided therein, for attaching to vehicles, and for generating warning lights for the vehicles, such as for generating warning lights to show or to indicate the side portions of the vehicles.

In accordance with one aspect of the invention, there is provided a decorative device for attaching onto objects, the decorative device comprising an elongate housing including a bottom panel having an outer peripheral portion, a peripheral wall extended from the outer peripheral portion of the bottom panel to define a chamber in the elongate housing, the housing including an inner peripheral channel formed therein and located close to the bottom panel thereof, the peripheral wall of the housing including a peripheral edge having a peripheral recess formed therein, a covering including an outer peripheral portion engaged into the peripheral recess of the peripheral wall of the housing, to secure the covering to the housing, a circuit board received in the chamber of the housing, and including an outer peripheral portion engaged in the inner peripheral channel of the housing, to retain the circuit board in the chamber of the housing, and one or more light devices attached to the circuit board to generate warning light. The housing may be attached to such as the side portions of the vehicles for lighting the side portions of the vehicles, and for preventing the side portions of the vehicles from being hit by the other vehicles.

The bottom panel includes at least one opening formed therein, and at least one electric wire engaged through the opening of the bottom panel and coupled to the circuit board.

The outer peripheral portion of the covering may include either a bent or a curved structure engaged into the peripheral recess of the peripheral wall of the housing.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a vehicle having a decorative device in accordance with the present invention attached thereto;

FIG. 2 is a perspective view of the decorative device; and

FIG. 3 is a cross sectional view taken along lines 3-3 of FIG. 2, illustrating the inner structure of the decorative device.

### DETAILED DESCRIPTION OF THE PREFERRED EMBODIMENT

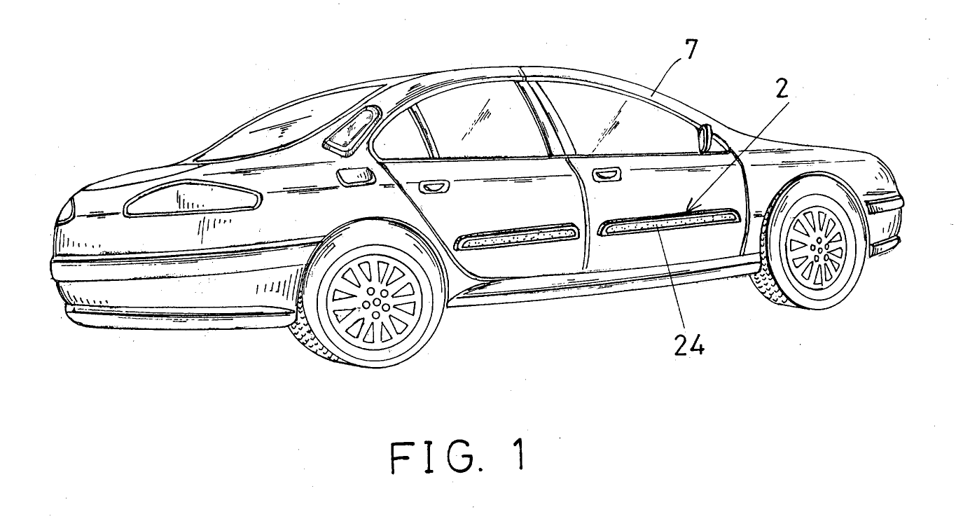

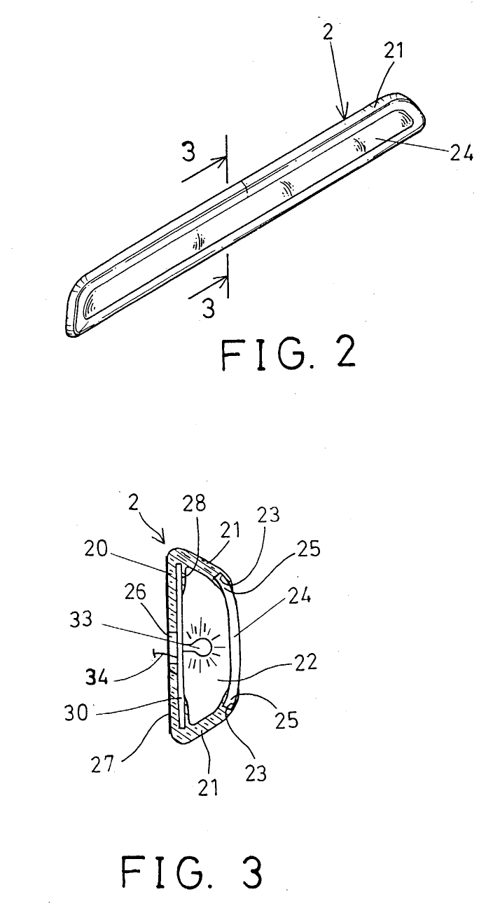

Referring to the drawings, and initially to FIGS. 1 and 2, a decorative device in accordance with the present invention comprises an elongate structure or housing 2 for attaching or securing to various objects, such as vehicles 7 (FIG. 1). Particularly, the elongate housing 2 may be attached to the front or rear portion or the side portions or other portions of the vehicles.

As shown in FIGS. 2 and 3, the elongate housing 2 of the decorative device includes an elongate bottom panel 20, a peripheral wall 21 extended laterally or upwardly from the outer peripheral portion of the elongate bottom panel 20 for forming or defining a chamber 22 in the elongate housing 2. As best shown in FIG. 3, it is preferable that the peripheral wall 21 is angled or inclined inwardly into the chamber 22 of the elongate housing 2.

The peripheral wall 21 of the elongate housing 2 includes an inner or free peripheral portion or edge having a peripheral recess 23 formed therein. A transparent or semi-transparent covering 24 has a bent or curved outer peripheral portion 25 engaged into the peripheral recess 23 of the elongate housing 2, for securing the covering 24 to the peripheral wall 21 of the elongate housing 2. The bottom panel 20 may include one or more openings 26 formed therein (FIG. 3).

The elongate housing 2 is also preferably made of transparent or semi-transparent materials, or rubber or plastic or synthetic materials, and is flexible, for allowing the elongate housing 2 to be easily bent or deformed and to be easily attached onto various portions of the vehicles 7 having various curvatures or shapes or contours. An adhesive layer 27 (FIG. 3) may be attached to the bottom panel 20 of the housing 2, for securing the housing 2 to various objects.

A circuit board 30 is further provided and engaged in the housing 2 which includes an inner peripheral channel 28 formed therein and formed beside or located close to the bottom panel 20 for receiving the outer peripheral portion of the circuit board 30, and for solidly securing and retaining the circuit board 30 in the housing 2.

One or more light devices 33, such as light bulbs, light crystal displayers, light emitting diodes, etc., attached to the circuit board 30 and received in the chamber 22 of the housing 2 for generating warning light through the covering 24 and/or the peripheral wall 21 of the housing 2. The light devices 33 may be coupled to batteries, vehicle power source (not shown), or the like with electric wires 34 that may be engaged through the openings 26 of the housing 2.

In operation, the light devices 33 may be optionally or selectively energized to generate warning light for various objects, such as for showing or indicating the side portions of the vehicles, for allowing the side portions of the vehicles to be clearly seen in the dark environment.

Accordingly, the decorative device in accordance with the present invention includes one or more light devices provided therein, for attaching to vehicles, and for generating warning lights for the vehicles, such as for generating warning lights to show or to indicate the side portions of the vehicles, and for preventing the side portions of the vehicles from being hit by the other vehicles or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A decorative device for attaching onto objects, said decorative device comprising:
an elongate housing including a bottom panel having an outer peripheral portion, a peripheral wall extended from said outer peripheral portion of said bottom panel to define a chamber in said elongate housing, said housing including an inner peripheral channel formed therein and located close to said bottom panel thereof, said peripheral wall of said housing including a peripheral edge having a peripheral recess formed therein,
a covering including an outer peripheral portion engaged into said peripheral recess of said peripheral wall of said housing, to secure said covering to said housing,
a circuit board received in said chamber of said housing, and including an outer peripheral portion engaged in said inner peripheral channel of said housing, to retain said circuit board in said chamber of said housing, and
at least one light device attached to said circuit board to generate warning light.

2. The decorative device according to claim 1, wherein said bottom panel includes at least one opening formed therein, and at least one electric wire engaged through said at least one opening of said bottom panel and coupled to said circuit board.

3. The decorative device according to claim 1, wherein said outer peripheral portion of said covering includes a bent structure engaged into said peripheral recess of said peripheral wall of said housing.

4. The decorative device according to claim 1, wherein said outer peripheral portion of said covering includes a curved structure engaged into said peripheral recess of said peripheral wall of said housing.
